(19) United States
(12) Patent Application Publication
(10) Pub. No.: US 2014/0251987 A1
(43) Pub. Date: Sep. 11, 2014

(54) APPLIANCE MONITORING SYSTEM AND METHOD WITH CONNECTIVITY AND COMMUNICATION PROTOCOLS

(71) Applicant: HAIER AMERICA TRADING, LLC, New York, NY (US)

(72) Inventor: Malcolm REAY, Saint Joseph, MI (US)

(73) Assignee: HAIER AMERICA TRADING, LLC, New York, NY (US)

(21) Appl. No.: 14/199,379

(22) Filed: Mar. 6, 2014

Related U.S. Application Data
(60) Provisional application No. 61/773,506, filed on Mar. 6, 2013.

(51) Int. Cl. F24C 7/08; G08B 21/22; H05B 6/64

(52) U.S. Cl. CPC F24C 7/088; H05B 6/6447; G08B 21/22
USPC 219/756; 219/446.1; 340/686.6

(57) ABSTRACT

A method and system for monitoring the proximity of a user to an appliance is provided. A motion detector is activated. The motion detector detects when a user is within a predetermined proximity of an appliance. A timer is initiated when the motion detector does not detect that the user is within the predetermined proximity to the appliance. It is determined from the timer whether a first predetermined period of time has elapsed since the motion detector determined that the user was not within the predetermined proximity of said appliance. A warning alert is sent to the user indicating that the first predetermined period of time has been exceeded since the motion detector determined that the user was not within the predetermined proximity of the appliance.

### CROSS REFERENCE TO RELATED APPLICATIONS

This application claims the benefit of U.S. Provisional Application No. 61/773,506, filed Mar. 6, 2013, the contents of which are incorporated by reference herein.

### BACKGROUND OF THE DISCLOSURE

1. Field of the Disclosure

The present disclosure generally relates to an appliance, e.g., cook top and/or range cook top, monitoring system and method which utilizes a motion sensor, power or gas flow interruption device, and communication alert devices to alert the operator that the cook top and/or range cook top has been unattended for a predetermined period of time. More particularly, if the motion sensor does not detect the presence of an operator for a predetermined period of time, then a transmitted signal activates the interrupt device, thereby shutting off the power or gas flow to the cook top and/or range cook top.

2. Discussion of Related Art

Automatic shut off mechanisms have a variety of applications ranging from the operation and control of power tools and lawn mowers to computers and automotive vehicles. Household items and health and beauty products, such as hair dryers, curling irons, and cloth pressing irons also come equipped with some type of automatic shut off mechanism that turns the item off after a predetermined time period of non-use elapses.

Such shut off features serve several critical purposes, most importantly, saving energy and safety. Many home fires are caused by an item, such as an iron or range, inadvertently left on while the residents leave the room or leave the house to run errands or go shopping only to return and find that a major house fire has occurred because some household item was not turned off. Thus, it is desirable to have a safety shut off system incorporated into the electrical circuitry of the house that automatically shuts off items, such as household appliances, that, if left on, could cause a major house fire and injury or death to the resident(s) of the household.

Cook top and/or range cook top manufactures have always been concerned with safety. Overcooking a product by cooking beyond a predetermined time or leaving cook tops and/or ranges unattended for a predetermined period of time can result in safety hazards, i.e. overcooking of food product, fires, etc. There have been a number of attempts by the industry to enhance the safety and eliminate overcooking or fires.

The prior art shows numerous automatic shut off systems for a variety of applications. One attempt is set forth in U.S. Pat. No. 5,717,188 (Vaillancourt) provides a safety device for electric stoves and overs wherein there is a provided a sensor for sensing when the stove is heating at a certain rate which could constitute a safety hazard and a sensor for detecting the presence of a person within a predetermined area proximate to the stove. When a certain period of time passes without motion by a person in the predetermined area while the stove is in the predetermined operating condition, power to the stove can be reduced.

U.S. Pat. No. 6,294,994 (Hoellerich) discloses an attendance monitoring apparatus for an appliance, such as an electrical appliance, which also includes a housing and a motion sensor assembly contained in the housing. A timer assembly is electrically connected to the motion sensor assembly, and an alarm assembly electrically connected to the timer assembly. The timer assembly is adjustable for selecting a range of predetermined time intervals. Optionally, a current controller is electrically connected to the timer assembly. The current controller controls electric power to the appliance, such as an electric stove. The attendance monitoring apparatus signals to a person with an audible alarm when the person has not attended to the electric stove for a predetermined period of time. Optionally, the attendance monitoring apparatus can turn off electrical power to the stove under these conditions.

U.S. Pat. No. 5,628,242 (Higley) discloses an automatic shut off for a gas cooker or grill that monitors activity with a motion detector and shuts off the grill when no activity has been detected for a predetermined time period.

US Patent Publication No. 2010/0188229 (Nhep) discloses a safety shut off system incorporated into the electrical circuitry of the house for shutting off an appliance after a predetermined time period elapses during which no physical movement within the vicinity of the appliance is detected. This includes a motion sensor interconnected to the breaker controlling the appliance whereupon the motion sensor signals the breaker to trip after the time period elapses in which no movement is detected, a contactor that allows current flow between the motion sensor and the breaker, and a relay inter-connected to the appliance fan, light, and the breaker, whereupon turning on the appliance automatically actuates the fan and light. When the breaker is tripped for shutting off the appliance, the relay is actuated to shut off the fan and light.

U.S. Pat. No. 4,775,913 (Ekblad) discloses a control device for controlling the operation of an object for cooking such as a stove or the like. The presence of a user in the area of the stove is detected. When the user is present, the stove operation is enabled. After the user has been absent from the stove area for a first predetermined time, the stove is temporarily disabled, and again enabled when the user reenters the area. If the user is absent from the area of the stove for a second predetermined time, the stove is permanently disabled, and so that it cannot again be enabled without being manually reset.

Some additional shut off system are disclosed in U.S. Pat. Nos. 5,380,985 and 6,130,413, and US Patent Publication No. 2010/0182136.

The present disclosure provides a novel system and method that improves upon the conventional shut off design discussed above by providing a unique and novel early warning to the user that they have left the cook top and/or range cook top unattended and running. Further, if there is no intervention by the user, the system will automatically shut off the gas or electric heat source and then contact the user to let them know that the cook top operation has been shut down. This novel method and system of the present disclosure can conserve energy, and prevent spoiled food or burned food and bad odor associated therewith, as well prevent cooking oil from igniting and starting a fire.

The above-described and other features and advantages of the present disclosure will be appreciated and understood by those skilled in the art from the following descriptions, drawings, and claims.

### BRIEF SUMMARY OF THE DISCLOSURE

The present disclosure monitors the activity on the cook top of gas and electric free standing ranges. The present disclosure can also be applicable to built-in cook tops and many other residential appliances.

A method and system for monitoring the proximity of a user to an appliance is provided. The method includes the steps of activating a sensor or detector, determining if the user is within a predetermined proximity of the appliance, initiating a timer or counter if the user is within the predetermined proximity to the appliance, determining if the timer or counter has reached a first predetermined period of time since the user was not within a predetermined proximity of the appliance, and sending a warning alert to the user that the first predetermined period of time has elapsed, been met, or exceeded since the user was not within a predetermined proximity of the appliance. The method and system can further comprise determining if the timer or counter has reached a second predetermined period of time since the user was not within a predetermined proximity of the appliance and determining if the user has turned the appliance to an off state. If the user has not turned the appliance to an off state, the method further includes turning the appliance off, and sending a second warning alert to the user that the second predetermined period of time has, elapsed, been met, or exceeded since, for example, the sensor or detector determined that the user was not within a predetermined proximity of the appliance.

The appliance can be a cook top, cook top of a range, grill, smoker, ventilation hood, microwave oven, and garbage compactor. Preferably, the appliance is a cook top comprising either a burner or heating element which has an on and an off state. The method can further include the steps of determining if a burner or heating element of the appliance is in an on state prior to the step of determining with a sensor if the user is within the predetermined proximity of the cook top.

The sensor can be a motion detector, camera, or light beam. The first and second warning alerts are sent to the user via wired or wireless communication to a user accessible receiving device. The user accessible receiving device can be a telephone, smart phone PDA, cell phone, laptop, notebook, personal computer, tablet, and any other medium having communication receiving capabilities.

A computer readable storage medium containing executable computer program instructions which when executed can cause a processing system to perform the method of the present disclosure.

A system for monitoring the proximity of a user to an appliance is also provided, the system includes a sensor or motion detector to determine if the user is within a predetermined proximity of the appliance, a timer or counter to determine a first predetermined period of time since the motion detector determined that the user was not within a predetermined proximity of the appliance, and a warning alert device that communicates to the user that the first predetermined period of time has elapsed, been met, or exceeded since it was determined that the user was not within a predetermined proximity of the appliance.

The timer or counter can also determine if a second predetermined period of time has elapsed since the sensor determined that the user was not within a predetermined proximity of the appliance and an appliance status sensor for determining the whether an appliance is in an on or off state, such as, if the user has turned the appliance off. If the user has not turned the appliance off, the system can automatically turn the appliance off by sending a signal to an interrupt device. The warning alert device communicates to the user that the second predetermined period of time has elapsed since the sensor or motion detector determined that the user was not within a predetermined proximity of the appliance.

When the cook top burners or heating elements are in operation, a sensor monitors for the presence and activity of the user, and if the presence or activity is no longer detected after a time less than that which will turn off the cook top burners or heating elements, the control will attempt to contact the user by means of a wired (i.e. current state of the art power line communication protocol) or wireless (i.e. current state of the art wireless communication to a smart phone, PDA, cell phone, laptop, net book, tablets and other wireless devices) communication device to notify the user that the cook top or range cook top has been left unattended.

When the cook top burners or heating elements are in operation, a sensor monitors for the presence and activity of the user, and if the presence or activity is no longer detected after a pre-determined time, the cook top burners or heating elements will be turned off, the controller will attempt to contact the user by a wired (i.e. current state of the art power line communication protocol) or wireless (i.e. current state of the art wireless communication to a smart phone, PDA, cell phone, laptop, net book, tablets and other wireless devices) communication network and device to notify the user that the cook top or range cook top has been turned off and some user action will be required to reset the appliance to allow the cook top to be used again.

Further objects, features, and advantages of the present disclosure will be understood by reference to the following drawings and detailed description.

### BRIEF DESCRIPTION OF THE DRAWINGS

FIG. 1 is a schematic representation of a range having a monitor control sensor which senses the presence of a user according to the present disclosure;

FIG. 2 is a schematic representation of a wireless alert being sent from the monitor control via a supplier's cloud or server to a user's home phone, smart phone, cell phone, personal computer, laptop, etc. according to the present disclosure;

FIG. 3 is a schematic representation of an audible alert being activated by the monitor control transmitting a signal to an audio device;

FIG. 4 is a schematic representation of an alert being sent from the monitor control via a power line and a supplier's cloud or server to a user's home phone, smart phone, cell phone, personal computer, laptop, etc. according to the present disclosure;

FIG. 5 is a schematic representation of an alert signal being sent from the monitor control directly to a user's home phone, smart phone, cell phone, personal computer, laptop, etc. according to the present disclosure;

FIG. 6 is a flowchart of the process of the monitor control alerting a user that a cook top and/or range cook top cook top has been unattended for a predetermined period of time and shutting off the cook top and/or range cook top cook top after a second predetermined period of time and alerting user that the cook top and/or range cook top cook top has been shut off;

FIG. 7 is a flowchart according to another embodiment of the present disclosure, wherein the monitor control alerts the user that the cook top and/or range cook top cook top has been unattended for a first predetermined period of time and determining if the user has return to within a predetermine proximity of the cook top and/or range cook top cook top before a second predetermined period of time has elapsed; and

FIG. 8 is a block diagram of a computer system which operates the method and system according to the present disclosure.

### DETAILED DESCRIPTION OF THE DISCLOSURE

A method and system for monitoring a user's proximity to a cook top and/or range cook top. The system comprises a motion sensing device that detects whether a user is within a predetermined proximity to a cook top and/or range cook top cook top, an electronic control board, an electrical power or gas flow interruption device, and a communication device or network to send information to the user via an audio alert or wired or wireless communication to a user accessible device, e.g., cell phone, smart phone, PDA, pager, personal computer, laptop, notebook, tablet, or any other communication medium having receiving capabilities.

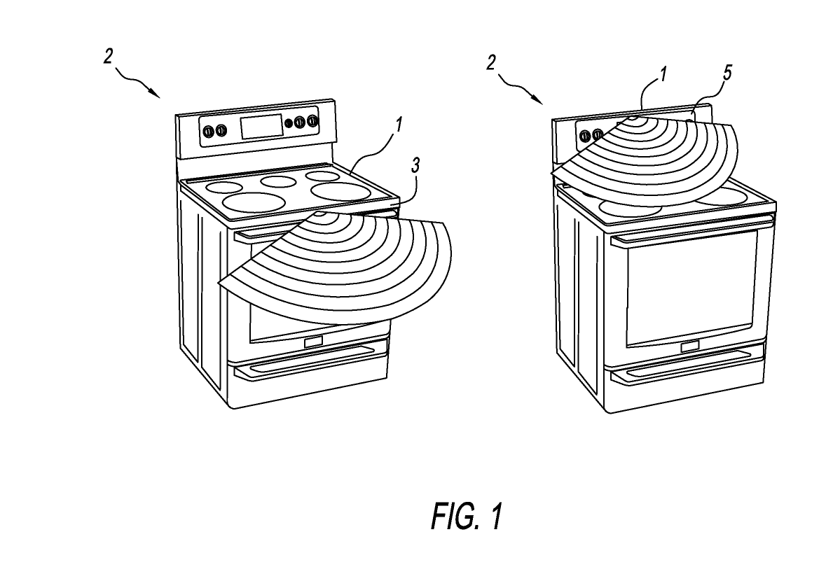

Referring to the drawings and in particular, FIG. 1, sensor 1, a range monitor control sensor, is shown disposed either on a front portion 3 of a cook top 2 or on console 5 or a control panel of cook top 2. Sensor 1 senses the presence of a user (not shown) by, e.g. a motion sensor, an optical sensor, infra-red sensor, or any other sensor technique capable of detecting the presence of a user within a predetermined proximity to cook top 2. Alternatively, sensor 1 can be replaced with a camera, beam, motion detector, or other device mounted on either the front portion 3 or console 5 of a gas, electric or induction free standing range or built-in cook top.

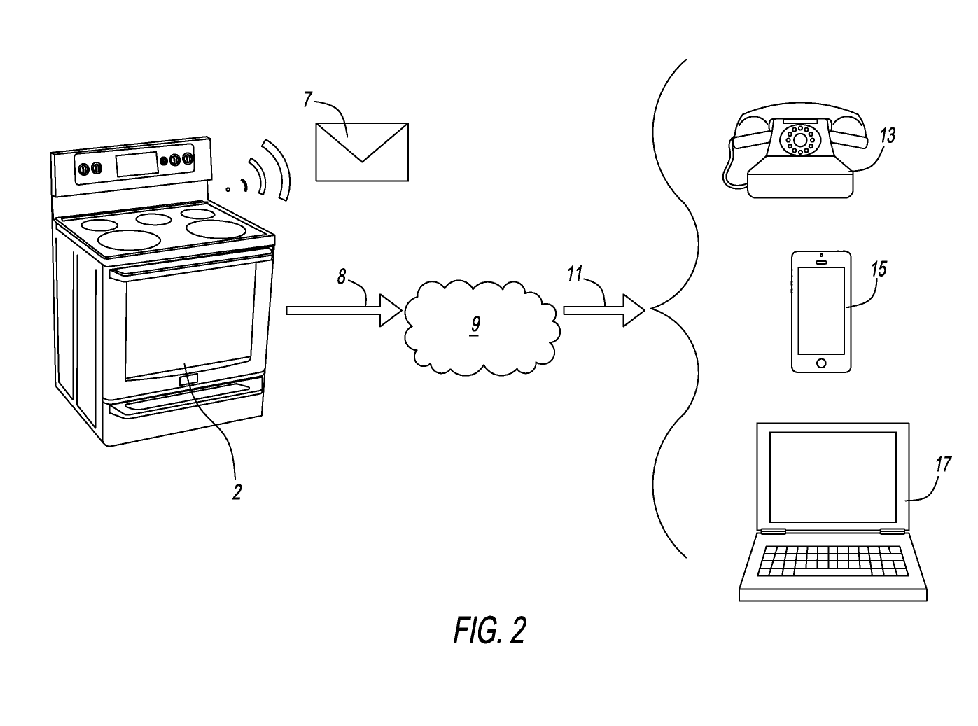

FIG. 2 is a schematic representation depicting a transmission 8 of a wireless message 7 from a range control monitor (not shown) of cook top 2 to a range supplier's server or cloud 9 via a network such as the internet (not shown). Cloud 9 sends 11 a text message or e-mail to user's home phone 13, smart phone 15, laptop 17, cell phone, personal computer or other devices (not shown).

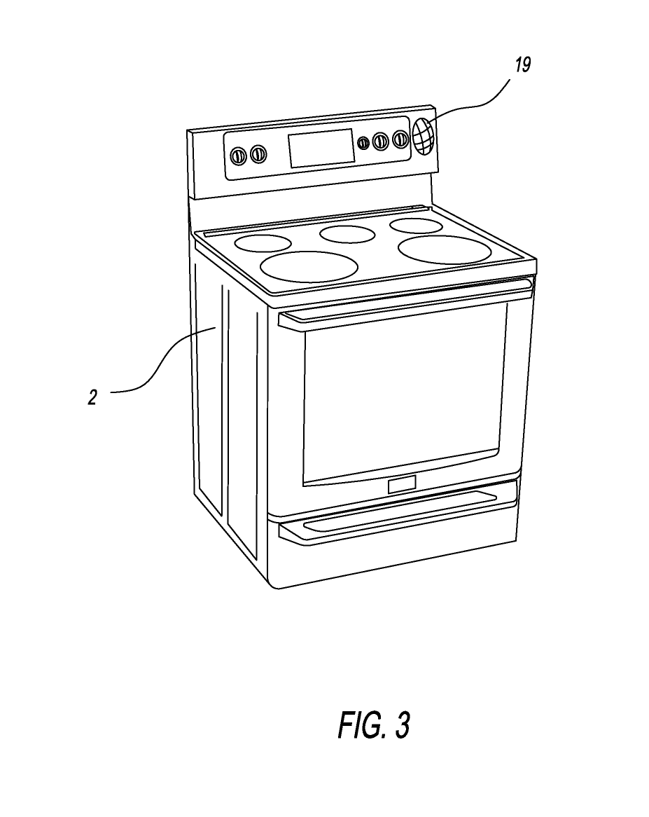

FIG. 3 is a schematic representation depicting a transmission of a signal to an audio alert device 19, e.g., speaker or other audio device incorporated in the range monitor control (not shown) or as part of cook top 2.

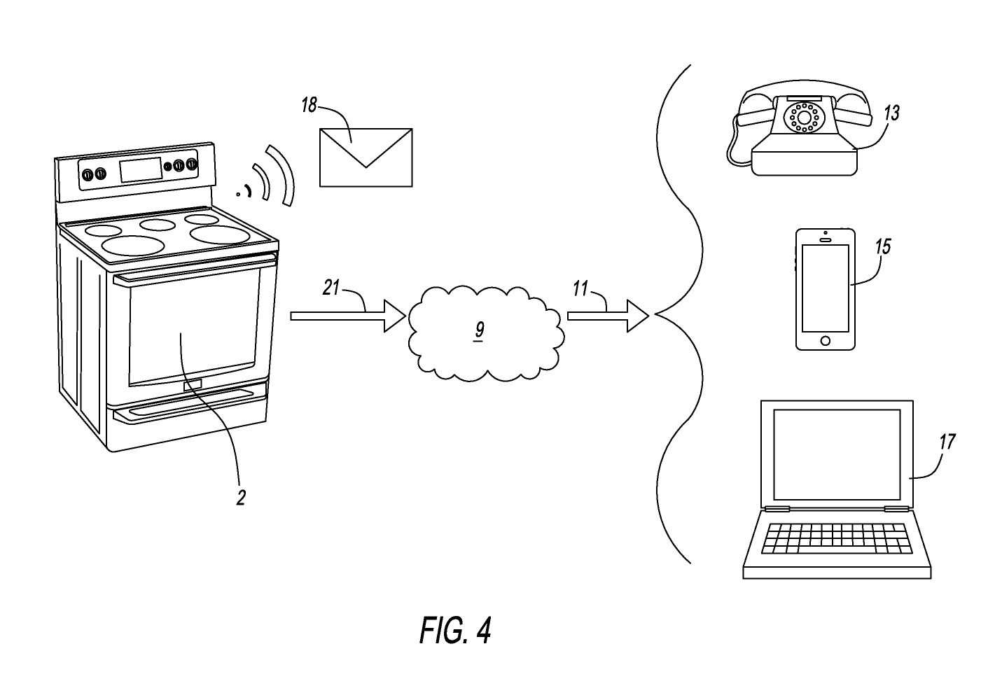

FIG. 4 is a schematic representation depicting a transmission of a message 20 via a power line 21 from the range control monitor to a range supplier's server or cloud 9 via a network such as the internet (not shown). Cloud 9 sends 11 message 18, a text message or e-mail, to user's home phone 13, smart phone 15, laptop 17, cell phone, personal computer, or other devices (not shown).

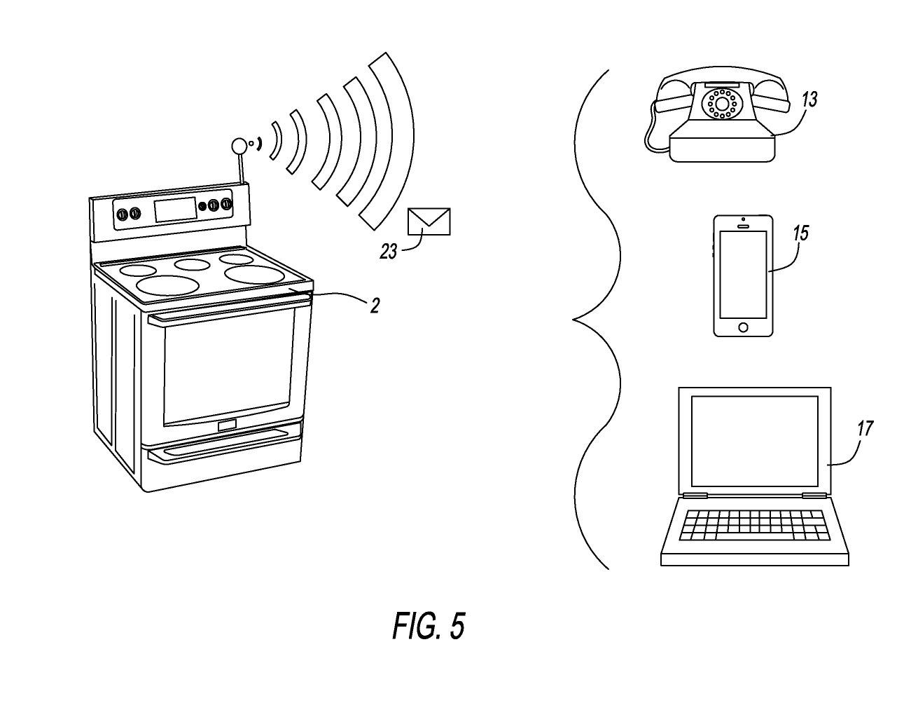

FIG. 5 is a schematic representation depicting the transmission of a phone or text message 23 from the range control monitor (not shown) directly to user's home phone 13, smart phone 15, notebook, laptop 17, cell phone, personal computer, or other devices (not shown).

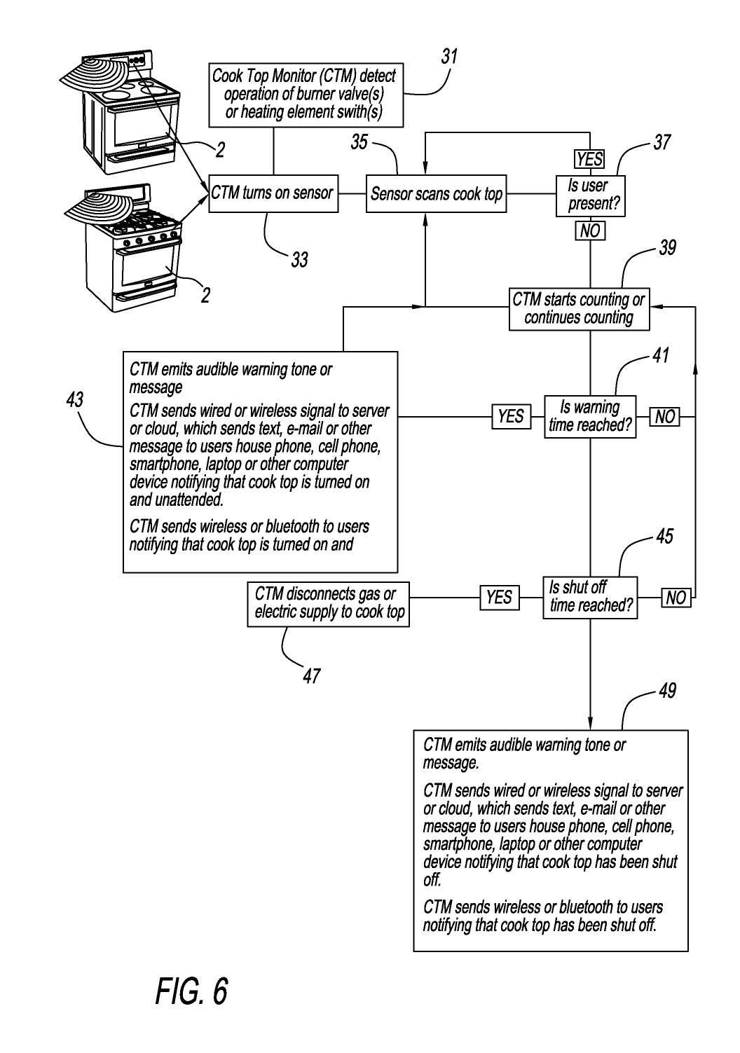

FIG. 6 is a flowchart of the process flow according to the present disclosure, wherein cook tops 2 comprise a cook top monitor (CTM) which detects operation of burner valve(s) or heating element switch(s) 31. Upon detection, CTM turns on sensor 33 which scans the cook top 35. The processor then determines via the scan if the user is present 37. If the user is present, then it returns to step 35. If the user is not present, then the CTM starts counting or continues counting 39. The system then checks to see if a first warning or predetermined time period 41 has been reached since counting has started. If the predetermined time period has not been reached, then it returns to step 39 to continue counting. If, however, the predetermined time period was reached, then the system enables 43 at least one of the following: (1) CTM sends a wired or wireless signal to server or cloud, which sends a text, e-mail or other electronic message to user's home phone, cell phone, smart phone, laptop or other computer device notifying the user that the cook top is turned on and unattended, and (2) CTM sends a wireless or Bluetooth to user notifying that the cook top is turned on and unattended.

Thereafter, the system re-initiates sensor scans of the cook top at step 35 until the CTM counter at step 39 reaches a shut off time 45. If shut off time 45 is not reached, then the system returns to counting 39. If shut of time 45 is reached, then the CTM disconnects or interrupts gas or electric power supply to cook top 47 and enables 49 at least one of the following: (1) CTM sends a wired or wireless signal to server or cloud, which sends a text, e-mail or other electronic message to user's home phone, cell phone, smart phone, laptop or other computer device notifying the user that the cook top is turned off, and (2) CTM sends a wireless or Bluetooth to user notifying that the cook top is turned off.

As used herein off refers to a de-energized, inactive, or off state of an appliance. For example off can refer to cooktop burners or heating elements being inactive. It also can refer to a state in which there is no fuel or gas being provided to the burner.

Optionally, instead of use with a cook top, the range monitor control sensor can be mounted on the front of an indoor or outdoor grill, an indoor or outdoor smoker, a ventilation hood, a microwave oven, a toaster oven, a toaster, a gas over, an electric over, or a garbage (trash) compactor or any other appliance requiring an alert.

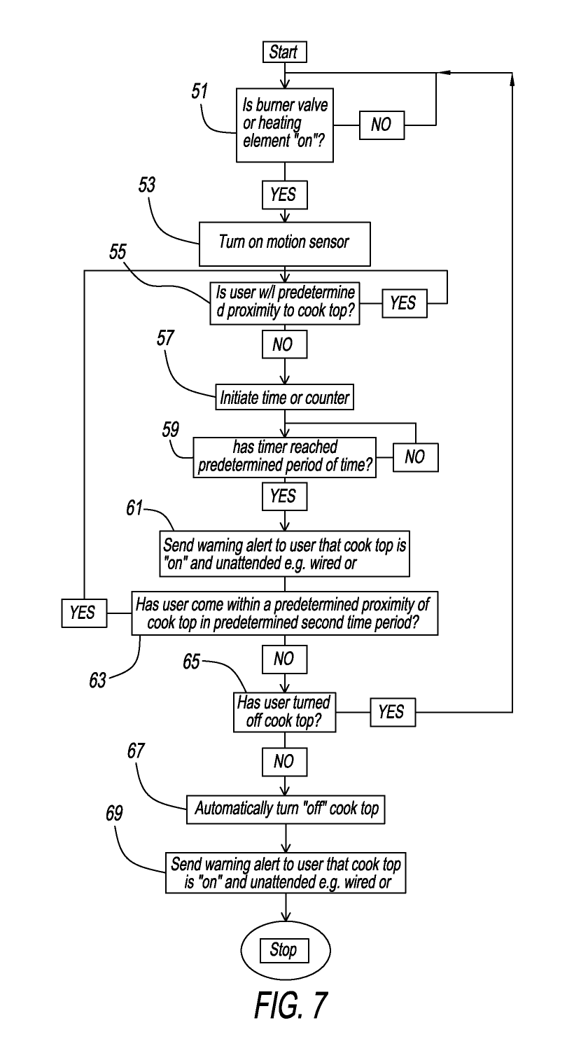

FIG. 7 describes another embodiment according to the present invention, wherein the method and system for monitoring a cook top initially checks to determine if the burner valve or heating element 51 is on. If not on, then the system returns to the top of the process. If on, then the system turns on the motion sensor 53 and checks to determine if the user is within a predetermined proximity to the cook top 55. If the user is within the predetermined proximity to the cook top, then the system continues to monitor the proximity of the user to the cook top. If the user is not within the predetermined proximity to the cook top, then the system initiates a timer or counter 57 and continuously checks to see if the timer has reached a predetermined period of time since the system determined that the user was not within the predetermined proximity to the cook top 59. If the timer has not reached a predetermined period of time, then it continues to check, so that once the timer has reached a predetermined period of time since the monitor determined that the user was not within the predetermined proximity of the cook top, the system send or transmits a warning alert to the user 61. The warning alert advises the user that the cook top is on and unattended, e.g., the alert can be either a wired or wireless transmission signal being sent to previously selected user device which is capable of receiving a wired or wireless alert signal.

Thereafter, the system continues to count or time how long it has been since the motion detector has last determined that the user was not within a predetermined proximity of the cook top, so as to determine if the user has not come within a predetermined proximity of the cook top within a second predetermined period of time 63. If the user has come within the predetermined proximity of the cook top before the second predetermined period of time, then the system resets to counter or timer to zero and returns to step 55 to begin monitoring to for when the user is no longer in a predetermined proximity to the cook top.

However, if the user does not come within a predetermined proximity of the cook top within a second predetermined time period, then the system checks to see if the user has turned the cook top off 65. If the cook top has been turned off, then the system returns to step 51. If the cook top has not been turned off, then the system automatically turns the cook top off 67 and sends a warning alert to the user advising that the cook top has been turned off 69, e.g., the alert can be either a wired or wireless transmission signal being sent to previously selected user device which is capable of receiving a wired or wireless alert signal.

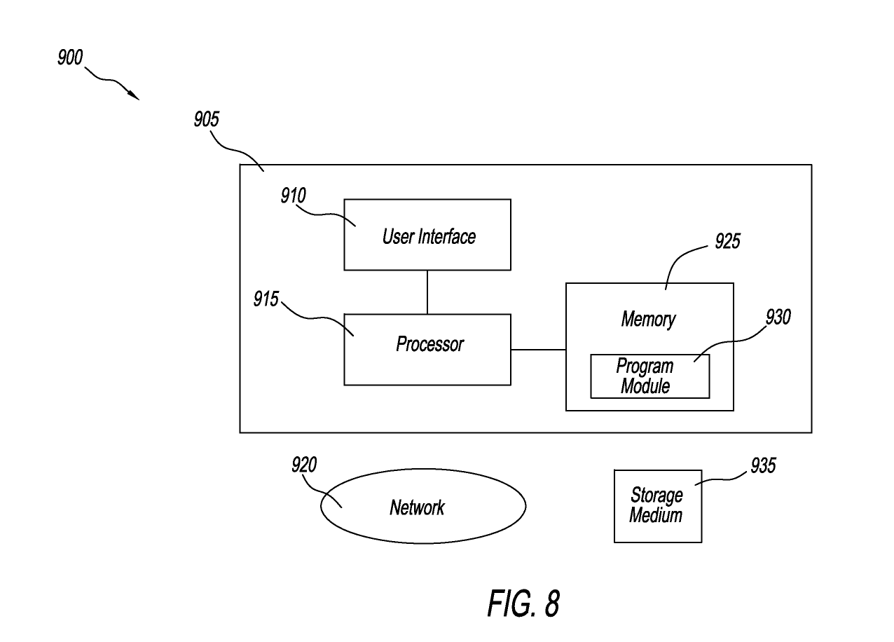

FIG. 8 is a block diagram of a system 900, for employment of the present invention. System 900 includes a computer 905 coupled to a network 930, e.g., the Internet.

Computer 905 includes a user interface 910, a processor 915, and a memory 920. Computer 905 may be implemented on a general-purpose microcomputer. Although computer 905 is represented herein as a standalone device, it is not limited to such, but instead can be coupled to other devices (not shown) via network 930.

Processor 915 is configured of logic circuitry that responds to and executes instructions.

Memory 920 stores data and instructions for controlling the operation of processor 915. Memory 920 may be implemented in a random access memory (RAM), a hard drive, a read only memory (ROM), or a combination thereof. One of the components of memory 920 is a program module 925.

Program module 925 contains instructions for controlling processor 915 to execute the methods described herein. For example, as a result of execution of program module 925, processor 915 activates a motion detector; determines by means of the motion detector if the user is within a predetermined proximity of the appliance; initiates a timer or counter if the motion detector does not detect that the user is within the predetermined proximity to the appliance; determines if the timer or counter has reached a first predetermined period of time since the motion detector determined that the user was not within a predetermined proximity of the appliance; and sends a warning alert to the user that the first predetermined period of time has been met or exceeded since the motion detector determined that the user was not within a predetermined proximity of the appliance. Processor 915 further determines if the timer or counter has reached a second predetermined period of time since the motion detector determined that the user was not within a predetermined proximity of the appliance; and determines if the user has turned the appliance off. If the user has not turned the appliance off, processor 915 automatically turns the appliance off; and sends a second warning alert to the user that the second predetermined period of time has been met or exceeded since the motion detector determined that the user was not within a predetermined proximity of the appliance.

The term “module” is used herein to denote a functional operation that may be embodied either as a stand-alone component or as an integrated configuration of a plurality of sub-ordinate components. Thus, program module 925 may be implemented as a single module or as a plurality of modules that operate in cooperation with one another. Moreover, although program module 925 is described herein as being installed in memory 920, and therefore being implemented in software, it could be implemented in any of hardware (e.g., electronic circuitry), firmware, software, or a combination thereof.

User interface 910 includes an input device, such as a keyboard or speech recognition subsystem, for enabling a user to communicate information and command selections to processor 915. User interface 910 also includes an output device such as a display or a printer. A cursor control such as a mouse, track-ball, or joy stick, allows the user to manipulate a cursor on the display for communicating additional information and command selections to processor 915.

Processor 915 outputs, to user interface 910, a result of an execution of the methods described herein. Alternatively, processor 915 could direct the output to a remote device (not shown) via network 930.

While program module 925 is indicated as already loaded into memory 920, it may be configured on a storage medium 935 for subsequent loading into memory 920. Storage medium 935 can be any conventional storage medium that stores program module 925 thereon in tangible form. Examples of storage medium 935 include a floppy disk, a compact disk, a magnetic tape, a read only memory, an optical storage medium, universal serial bus (USB) flash drive, a digital versatile disc, or a zip drive. Alternatively, storage medium 935 can be a random access memory, or other type of electronic storage, located on a remote storage system and coupled to computer 905 via network 930.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for monitoring the proximity of a user to an appliance comprising, the method comprising:
detecting if said user is within a predetermined proximity of said appliance;
determining that a first predetermined period of time has elapsed since said user was not detected to be within said predetermined proximity of said appliance; and
sending a first alert to said user that said first predetermined period of time has elapsed.

2. The method according to claim 1, further comprising:
determining that a second predetermined period of time has elapsed since said user was not within a predetermined proximity of said appliance; and
determining that said appliance is on.

3. The method according to claim 2, further comprising:
sending a second alert to said user that said second predetermined period of time has elapsed since said user was not within a predetermined proximity of said appliance.

4. The method according to claim 2, further comprising:
turning off said appliance if said appliance is on.

5. The method according to claim 2, wherein a timer determines at least one of said first predetermined period of time and said second predetermined period of time.

6. The method according to claim 1, wherein said appliance is at least one selected from the group consisting of: cook top, cook top of a range, grill, smoker, ventilation hood, microwave oven, and garbage compactor.

7. The method according to claim 1, wherein said method further comprises:
determining that appliance is on prior to detecting if said user is within a predetermined proximity of said appliance, and wherein said appliance is a cooktop comprising at least one of a burner and heating element,.

8. The method according to claim 1, wherein a detector detects if said user is within said predetermined proximity of said appliance, wherein said detector is at least one selected from the group consisting of: a motion detector, camera, and light beam.

9. The method according to claim 1, wherein said first alert is sent to said user via a wired or wireless communication to a user accessible receiving device wherein said user accessible receiving device is at least one selected from the group consisting of: a telephone, smart phone, PDA, cell phone, laptop, notebook, personal computer, tablet, and any other communication medium having receiving capabilities.

10. A computer readable storage medium comprising executable computer program instructions which when executed cause a processing system to:
detect when a user is within a predetermined proximity of an appliance;
determine that a first predetermined period of time has elapsed since said user was not within said predetermined proximity of said appliance; and
send an alert to said user that said first predetermined period of time has elapsed.

11. The computer readable storage medium according to claim 10, further comprising executable computer program instructions which when executed cause a processing system to:
determine that a second predetermined period of time has elapsed since said user was not within a predetermined proximity of said appliance; and
determine whether said appliance is on.

12. The computer readable storage medium according to claim 11, further comprising executable computer program instructions which when executed cause a processing system to:
turn off said appliance if said appliance is on.

13. The computer readable storage medium according to claim 11, further comprising executable computer program instructions which when executed cause a processing system to:
send a second alert to said user that said second predetermined period of time has elapsed since said user was not within said predetermined proximity of said appliance.

14. A system for monitoring the proximity of a user to an appliance, said system comprises:
a detector to determine when said user is within a predetermined proximity of said appliance;
a timer to determine a first predetermined period of time has elapsed since said detector determined that said user was not within a predetermined proximity of said appliance; and
an alert device, wherein said alert device communicates to said user that said first predetermined period of time has elapsed.

15. The system according to claim 14, wherein said timer also determines when a second predetermined period of time has elapsed since said detector determined that said user was not within a predetermined proximity of said appliance; and further comprising: a sensor to determine whether said appliance is on or off.

16. The system according to claim 15, wherein said system turns said appliance to off.

17. The system according to claim 15, wherein and said alert device communicates to said user that said second predetermined period of time has elapsed since said detector determined that said user was not within a predetermined proximity of said appliance.

18. The system according to claim 14, wherein said appliance is at least one selected from the group consisting of: a cook top, cook top of a range, grill, smoker, ventilation hood, microwave oven, and garbage compactor.

19. The system according to claim 14, wherein said appliance is a cook top comprising at least one of a burner and heating element, wherein said system further comprises:
an appliance status sensor to determine whether said cook top of said appliance is on or off.

20. The system according to claim 14, wherein said alert device transmits an alert via a wired or wireless communication over a network to a user accessible receiving device, wherein said user accessible receiving device is at least one selected from the group consisting of: a telephone, smart phone, PDA, cell phone, laptop, notebook, personal computer, tablet, and any other medium having communication receiving capabilities.
